(19) United States
(12) Patent Application Publication
(10) Pub. No.: US 2026/0110619 A1
(43) Pub. Date: Apr. 23, 2026

(54) QUANTITATIVE EVALUATION METHOD OF ENGINE OIL-DERIVED DEPOSIT

(71) Applicant: SUBARU CORPORATION, Tokyo (JP)

(72) Inventors: Shota TOBE, Tokyo (JP); Masami SHIKI, Tokyo (JP); Naoki EGUCHI, Tokyo (JP); Kohei HASHIMOTO, Tokyo (JP)

(21) Appl. No.: 19/355,608

(22) Filed: Oct. 10, 2025

(30) Foreign Application Priority Data
Oct. 21, 2024 (JP) 2024-185053

(51) Int. Cl. G01N 17/00; G01N 5/04

(52) U.S. Cl. CPC G01N 17/008; G01N 5/04

(57) ABSTRACT

A quantitative evaluation method of an engine oil-derived deposit includes pre-processing, generating a deposit, and measuring an amount of deposit generation. In an inert gas atmosphere, the pre-processing heats engine oil to 270° C. or higher and holds the engine oil at the heated temperature in a predetermined period of time. In an air atmosphere, the generating the deposit sets the engine oil having undergone the pre-processing at a fixed temperature and holds the engine oil for 120 minutes or more at the set temperature. The measuring the amount of deposit generation measures the amount of generation of the deposit generated in the generating the deposit.

### CROSS-REFERENCE TO RELATED APPLICATIONS

The present application claims priority from Japanese Patent Application No. 2024-185053 filed on Oct. 21, 2024, the entire contents of which are hereby incorporated by reference.

### BACKGROUND

The present disclosure relates to a quantitative evaluation method of an engine oil-derived deposit and in particular to the quantitative evaluation method of the engine oil-derived deposit generated in a thermal environment simulating the inside of a gasoline engine.

It is known that engine oil deposits at various positions, as carbon deposits, in an engine of an internal combustion vehicle, and the deposited carbon deposits exert various types of influence on the performance and functions of the engine. Furthermore, there is social trend toward replacing petroleum-derived engine oil and fuel with carbon neutral engine oil and fuel (plant-derived engine oil and fuel) in the internal combustion vehicle. In line with this trend, the influence exerted by the carbon neutral engine oil and fuel on the performance and the functions of the engine is to be evaluated.

In view of the above, various test methods have been developed to quantitatively evaluate generation of carbon deposits in an environment simulating the inside of a gasoline engine for forecasting and studying the influence of the engine oil-derived and fuel-derived carbon deposits generated in the gasoline engine. Examples of such evaluation test methods include, for example, a hot-tube test and a panel-coking test as described in, for example, Japanese Unexamined Patent Application Publication (JP-A) 2-45595.

### SUMMARY

An aspect of the disclosure provides a quantitative evaluation method of an engine oil-derived deposit. The quantitative evaluation method includes pre-processing, generating a deposit, and measuring an amount of deposit generation. In an inert gas atmosphere, the pre-processing heats engine oil to 270° C. or higher and holds the engine oil at the heated temperature in a predetermined period of time. In an air atmosphere, the generating the deposit sets the engine oil having undergone the pre-processing at a fixed temperature and holds the engine oil for 120 minutes or more at the set temperature. The measuring the amount of deposit generation measures the amount of generation of the deposit generated in the generating the deposit.

### BRIEF DESCRIPTION OF THE DRAWINGS

The accompanying drawings are included to provide a further understanding of the disclosure and are incorporated in and constitute a part of this specification. The drawings illustrate embodiments and, together with the specification, serve to describe the principles of the disclosure.

FIG. 1 illustrates comparison of the appearances after a deposit generation test when the deposit generation test is performed without performing pre-processing;

FIG. 2 illustrates states of deposits at various temperatures when a heated temperature is varied in the pre-processing;

FIG. 3 illustrates the rate of deposit generation and physical states at various holding time periods in the generating the deposit;

FIG. 4 illustrates an FT-IR spectrum when the holding time is varied at 300°0 C. in the generating the deposit; and

FIG. 5 illustrates the rate of deposit generation at various set temperatures with respect to new oil and used oil in the generating the deposit.

### DETAILED DESCRIPTION

Table 1 below summarizes the related-art evaluation test methods including the hot-tube test and the panel coking test from the viewpoints of the type of oil to be tested, a thermal environment simulating an installation environment of the engine, whether generated deposits can be collected, whether the rate of deposit generation can be calculated, and testing time.

TABLE 1

| | | | Thermal environment simulating engine | | | | | |
|---|---|---|---|---|---|---|---|---|
| | | | installation environment | | | | | |
| | | | | 200 to 500° C. | | | | |
| | | | 100 to 200° C. | (combustion | 500 to 700° C. | Whether | Whether rate of | |
| | Oil type | | (intake system | chamber | (exhaust | generated | deposit | Testing time |
| | Engine oil | | thermal | thermal | system thermal | deposits can be | generation can | min/ |
| Test name | (lubricant) | Gasoline | environment) | environment) | environment) | collected | be calculated | sample |
| Hot-tube test | A | N/A | A | B | C | C | B | 960 |
| TEOST | A | N/A | A | B | C | C | B | 1440 |
| MHK/33C | | | | | | | | |
| Panel coking | A | N/A | A | B | C | A | C | 180 |
| test | | | | | | | | |
| Muffle furnace | A | N/A | A | A | C | A | A | 180 |
| Autoclave | A | A | A | A | B | A | A | 180 |

As indicated in Table 1, it is not a case that the related-art evaluation test methods in which only the engine oil is to be tested (the hot-tube test, a thermo-oxidation engine oil simulation test (TEOST) MHK/33C, the panel-coking test, and a muffle furnace) can perform the evaluation test of carbon deposits in all the thermal environments (that is, an intake system thermal environment which is a low thermal region, a combustion chamber thermal environment which is an intermediate thermal region, and an exhaust system thermal environment which is a high thermal region). For example, the above-described tests are to be performed at temperatures lower than or equal to temperatures described below and the tests cannot be performed at temperatures higher than those temperatures: the hot-tube test is to be performed at temperatures lower than or equal to 300° C. (the test is normally performed at 250° C. and 300° C.; the hot-tube test described in JP-A2-45595 is performed at 300°° C.); the TEOST MHK/33C is to be performed at temperatures lower than or equal to 285° C. (the test is normally performed at 200° C., 250°° C., 275° C., and 285° C.); the panel-coking test is to be performed at temperatures lower than or equal to 320° C. (the test is normally performed at 200°° C., 250°° C., and 300° C.; the panel-coking test described in JP-A2-45595 is performed at 320° C.); and the muffle furnace is to be performed at temperatures lower than or equal to 500° C. (the muffle furnace is normally performed at 300°° C. and 500° C.).

The evaluation test of whether the generated deposits can be collected is performed with a glass tube for testing or a glass test tube in the hot-tube test and the TEOST MHK/33C. However, when the deposits are collected, the glass tube for testing or the glass test tube, which is not assumed to be broken, is to be broken every time the test is performed. Thus, this evaluation test method is not realistic.

Regarding whether the rate of deposit generation (the amount of deposit generation/a specimen use amount in the test×100) can be calculated, the amount of splashed oil (the amount of use of specimens in the test) is not quantitatively found in the panel-coking test. Thus, the rate of deposit generation cannot be calculated.

In the hot-tube test and the TEOST MHK/33C, although the deposits cannot be directly collected, the amount of deposit generation can be found before and after the test, and the amount of use of specimens in the test can be found by flow management or the like. Thus, the rate of deposit generation can be indirectly calculated but cannot be directly calculated from the amount of actually collected deposits. Accordingly, these tests are evaluated as B in Table 1 above.

Regarding a test with an autoclave targeted at oil and gasoline, the autoclave is a classic device, and there is a drawback in that a improving unit for efficiently (in particular, automatically) performing an evaluation test cannot be easily applied. In the test with the autoclave, it is not the case that the evaluation test of the carbon deposits can be performed in all the thermal environments.

Regarding the testing time, time per test is 960 minutes (16 h) in the hot-tube test and 1440 minutes (24 h) in the TEOST MHK/33C. Thus, these tests are not highly efficient because of a high occupation rate of equipment per test.

It is desirable to provide an evaluation method that enables quantitative and efficient evaluation of an engine oil-derived carbon deposits generated in environments simulating all thermal environments of a gasoline engine (an intake system thermal environment, a combustion chamber thermal environment, and an exhaust system thermal environment).

The inventors have diligently studied to attain the above-described objective. As a result, the inventors have found that the above-described problem can be solved by performing specific pre-processing before generating a deposit, setting engine oil at a fixed temperature in the generating the deposit, and holding the engine oil at the set temperature for a certain period of time or more. Thus, the inventors have completed an embodiment of the present disclosure.

### Quantitative Evaluation Method of Engine Oil-Derived Deposit

According to the embodiment of the present disclosure, a quantitative evaluation method of an engine oil-derived deposit includes pre-processing, generating a deposit, and measuring the amount of deposit generation. In some embodiments, measuring a weight of engine oil and calculating the rate of deposit generation are included in the quantitative evaluation method of the engine oil-derived deposit.

### Pre-Processing

In the pre-processing, the engine oil is heated to a temperature of 270° C. or higher and held at the heated temperature in a predetermined period of time in an inert gas atmosphere.

The engine oil to be processed in the pre-processing is unused engine oil and used engine oil. In a case of the unused engine oil, when the pre-processing is performed, highly volatile components are evaporated so as to enable quantitative evaluation of deposit generation to be more precisely performed. In a case of the used engine oil, when the pre-processing is performed, gasoline components included in the used engine oil are evaporated so as to enable suppression of spurting of the engine oil due to boiling of the gasoline components in the generating the deposit. Furthermore, the highly volatile components are evaporated so as to enable the quantitative evaluation of the deposit generation to be more precisely performed.

In some embodiments, the inert gas atmosphere is an N₂ atmosphere. A lower limit value of the heated temperature is 270° C. or higher, preferably 280° C. or higher, and more preferably 290° C. or higher. An upper limit value of the heated temperature is preferably 300° C. or lower. Any combination of the upper limit values and the lower limit value can be used. By setting the lower limit value of the heated temperature to 270° C. or higher, retention of the gasoline components and the highly volatile components included in the engine oil can be prevented. By setting the upper limit of the heated temperature to 300° C. or lower, influence on components that are to become solid deposits can be suppressed.

A lower limit value of the heated temperature holding time is preferably 20 minutes or more and more preferably 30 minutes or more. An upper limit value of the heated temperature holding time is preferably 40 minutes or less. Any combination of the upper limit values and the lower limit value can be used. By setting the lower limit of the heated temperature holding time to 20 minutes or more, retention of the gasoline components and the highly volatile components included in the engine oil can be prevented. By setting the upper limit of the heated temperature holding time to 40 minutes or less, excessive volatilization of the oil can be suppressed.

In some embodiments, the device to be used in the pre-processing is a thermogravimetry differential thermal analysis (TG-DTA) apparatus.

### Generating Deposit

In the generating the deposit, the engine oil having undergone the pre-processing is set at a fixed temperature and held for 120 minutes at the set temperature to generate deposits in an air atmosphere.

By considering that the evaluation test is related to the amount (rate) of deposit generation with respect to the set temperatures, limitation of the range of the set temperatures is basically unnecessary. However, by considering the evaluation test is related to all the thermal environments in the gasoline engine (the intake system thermal environment, the combustion chamber thermal environment, and the exhaust system thermal environment) in the environment simulating the inside of the gasoline engine, the set temperature is in a range of 200 to 700° C. in some embodiments.

A lower limit value of the set temperature holding time is 120 minutes or more, preferably 150 minutes or more, and more preferably 180 minutes or more. By setting the set temperature holding time to 120 minutes or more, depositing can be stabilized as will be described in the embodiment later.

In some embodiments, the device to be used in the generating the deposit is the TG-DTA.

### Measuring Amount of Deposit Generation

In the measuring of the amount of deposit generation, the amount of deposit generation generated in the generating the deposit is measured.

In some embodiments, the device to be used in the measuring of the amount of deposit generation is the TG-DTA. In some embodiment, The TG-DTA, which can measure the amount of deposit generation over time, is used.

### Measuring Weight of Engine Oil and Calculating Rate of Deposit Generation

According to the embodiment of the present disclosure, the quantitative evaluation method of the engine oil-derived deposit can include the measuring the weight of engine oil and the calculating the rate of deposit generation for obtaining the rate of deposit generation.

The measuring the weight of engine oil is performed before the pre-processing and measures the weight of the engine oil to be provided in the pre-processing. The weight of the engine oil can be measured with a known measuring device.

The calculating the rate of deposit generation is performed after the measuring the amount of deposit generation and calculates the rate of deposit generation by using the following expression.

$$the amount of deposit generation ( g ) measured in measuring amount of deposit generation / weight of engine oil ( g ) measured in measuring weight of engine oil \times 100. \qquad Expression$$

### Others

The measuring of a weight of engine oil, the pre-processing, the generating the deposit, the measuring the amount of deposit generation, and the calculating the rate of deposit generation can be performed continuously without a break between steps or with a break between any steps.

When the pre-processing, the generating the deposit, and the measuring the amount of deposit generation are performed in the same device, any device can be used as long as the device can heat the engine oil, switch between the inert gas atmosphere and the air atmosphere, and measure the amount of deposit generation after completion of heating time. In particular, when the TG-DTA is used, the TG-DTA can heat the engine oil, switch between the inert gas atmosphere and the air atmosphere, and measure the amount of deposit generation during the heating over time. In addition, the TG-DTA can automatically continuously perform the pre-processing, the generating the deposit, and measuring the amount of deposit generation. Thus, the TG-DTA is used from the viewpoints of work efficiency in some embodiments.

### EMBODIMENTS

The embodiment of the present disclosure is described below by indicating embodiments. Note that the embodiment of the present disclosure is not limited to these embodiments.

### Study of Meaning of Pre-Processing by Evaluating Influence of Gasoline Component in Deposit Generation Test

Oil having been used in the engine of an actual vehicle unavoidably includes the gasoline components because the gasoline injected into the cylinder is scraped off into the crankcase and mixed with the oil. That is, when the used oil is used in the deposit generation test without performing the pre-processing, the influence of the gasoline components is also evaluated. Thus, to determined whether the gasoline components influence in the deposit generation test, the deposit generation test was performed with used oil and new oil. The pre-processing was performed on neither the used oil nor the new oil. As the engine oil, genuine gasoline engine oil 5W-30 by SUBARU (registered trademark) was used (the same engine oil is used in the study to be described later).

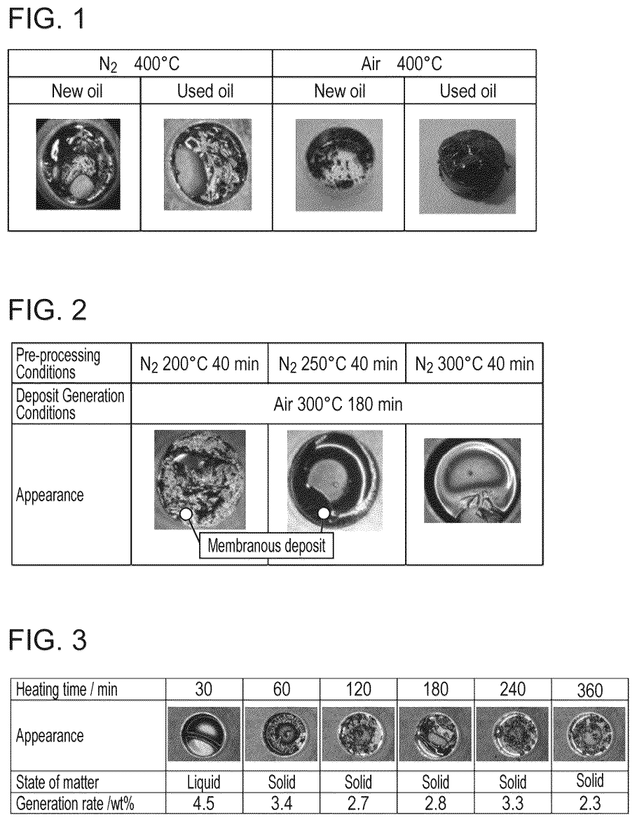

The test conditions were set as follows: the atmospheric gas condition was set to two conditions, that is, N₂ and air, the heated temperature was set to 400° C., and heating time was set to 180 minutes. As experimental equipment, a simultaneous differential thermal and thermogravimetric analyzer (TG-DTA, STA7000 made by Hitachi High-Tech Science Corporation) was used. The results of the experiment are illustrated in FIG. 1. From the experimental results, it has been found that the amount of deposit generation cannot be precisely evaluated because the container was overflowed with the used oil during the heating of the used oil.

Accordingly, it has been found that the pre-processing (for example, pre-processing to remove the gasoline components from the used oil for enabling the deposit generation test to be performed in the air atmosphere) is to be used.

### Study of Conditions of Pre-Processing

The conditions of the pre-processing were studied by using the used oil and fixing the conditions of the deposit generation test to 300° C. and the holding time to 180 minutes in the air atmosphere. In the conditions of the pre-processing with the holding time set to 40 minutes, a temperature rise speed set to 10° C./minutes in the N₂ atmosphere, and the heated temperature in the pre-processing set to 200° C., 250° C., and 300°° C., a state of the deposits generated in the deposit generation test with the pre-processing performed at each temperature was checked. As experimental equipment, the simultaneous differential thermal and thermogravimetric analyzer (TG-DTA, STA7000) was used. The results of the experiment are illustrated in FIG. 2. From the experimental results, it has been found that, when the heated temperature of the pre-processing is 200° C. and 250° C., a membranous deposits are generated on the upper side of the container after the generating the deposit. This membranous deposits are not generated in the pre-processing. Thus, conceivably, the gasoline included in the oil influence during the deposit generation test. In contrast, the membranous deposits are not generated when the heated temperature of the pre-processing is 300° C. Thus, conceivably, the gasoline included in the oil does not influence during the deposit generation test (that is, deposits of oil components only are generated).

Accordingly, it has been found that, in some embodiments, in the conditions of the pre-processing, the heated temperature is 300°° C. and the heated temperature holding time is 40 minutes in the N₂ atmosphere.

Study of State and Generation Rate of Generated Deposit with Respect to Set Temperature Holding Time in Deposit Generation Test

In the conditions of the pre-processing with the set temperature set to 300° C., the temperature rise speed set to 10° C./minutes, and the holding time is set to 40 minutes in the N₂ atmosphere and in the conditions of deposit generation with the set temperature set to 300° C. and the holding time set to 30 minutes, 60 minutes, 120 minutes, 180 minutes, 240 minutes, and 360 minutes in the air atmosphere, the rate of deposit generation generated in each holding time is checked. Furthermore, the state of matter of the deposits is classified into two states, the liquid and the solid. The results of the experiment are illustrated in FIG. 3.

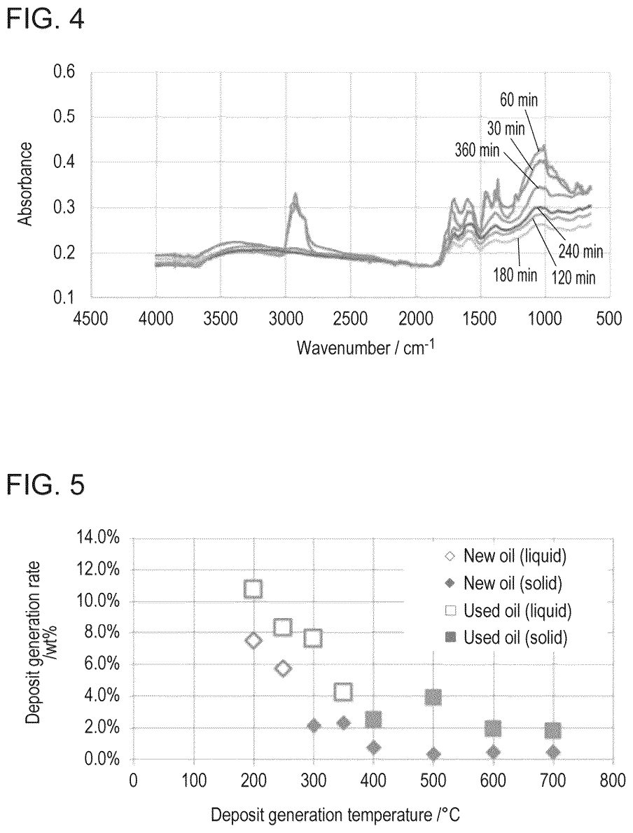

The stability of reaction of the depositing was checked from the state of the functional group by using a Fourier transform infrared spectrometer (FT-1R, 5500a made by Agilent Technologies, Inc.) The results of the experiment are illustrated in FIG. 4.

When the heated temperature holding time is 30 minutes, the deposits are still in the liquid state, and the waveform of the FT-IR has not significantly changed from a non-processed state. When the heated temperature holding time is further increased, the deposits change from the liquid state to the solid state, and the peak of the waveform of the FT-IR reduces near 2900 cm⁻¹ and increases at 1750 cm⁻¹ or less. Regarding these results, the reduction of the peak near 2900 cm⁻¹ means reduction of the detergent additive, and the increase of the peak at 1750 cm⁻¹ or less indicates generation of oxidation carbonyl products (COO³¹ ).

Conceivably, in some embodiments, the heated temperature holding time is at least 120 minutes because the waveform of the FT-IR stabilizes at and after 120 minutes. Conceivably, in some embodiments, the heated temperature holding time is 180 minutes because the depositing takes place reliably.

The above-described experimental results are summarized in Table 2 below.

TABLE 2

| | | | Heating conditions | |
|---|---|---|---|---|
| | | | Temperature rise | |
| | Gas | Heated/Set | (fall) speed | |
| | atmosphere | temperature (° C.) | (° C./min) | Holding time |
| Pre-processing | N2 | 300 | 10 | 40 |
| conditions | | | | |
| Deposit | Air | *1 | 10 | At least 120 min |
| generation | | | | |
| conditions | | | | |

*1: The set temperature is 300° C. in the above-described “Study of State and Generation Rate of Generated Deposit with respect to Heated Temperature Holding Time in Deposit Generation Test.” The set temperature is in a range of 200 to 700° C. in “Study of Rate of Deposit Generation with respect to Heated Temperature in Deposit Generation Test with New Oil and Used Oil.”

Study of Rate of Deposit Generation with Respect to Set Temperature in Deposit Generation Test with New Oil and Used Oil

The rate of deposit generation was studied with respect to the heated temperature of the deposit generation test with the new oil and the used oil (genuine gasoline engine oil 5W-30). The pre-processing was performed with the heated temperature set to 300° C. and the holding time set to 40 minutes in the N₂ atmosphere, and the deposit generation test was performed with the holding time fixed to 180 minutes and the set temperature is in eight conditions, that is, 200° C., 250° C., 300°° C., 350°° C., 400°° C., 500°° C., 600° C., and 700° C. in the air atmosphere. As experimental equipment, the simultaneous differential thermal and thermogravimetric analyzer (TG-DTA, STA7000) was used. The results of the experiment are illustrated in FIG. 5. In the graph indicating the test results, the liquid deposits are indicated by open symbols, and the solid deposits are indicated by solid symbols. The rate of deposit generation is obtained by the following expression: amount (g) of deposit generation/weight (g) of engine oil used in experiment×100.

With the new oil, the deposits exhibited the physical properties of liquid-state deposits (partially including solid-state deposits) at 200 to 250° C., and the deposits became solid at 300° C. or higher. The rate of deposit generation was 2.0 wt % at 300 to 350° C. Meanwhile, with the used oil, the deposits exhibited the physical properties of liquid-state deposits (partially including solid-state deposits) at 200 to 350° C., and the deposits became solid at 400° C. or higher. At any heated temperature, the rate of deposit generation was higher with the used oil than with the new oil. At 500° C., the used oil indicates 3.9 wt %, which was 13 times higher than the new oil.

By using the pre-processing conditions and the deposit generation conditions of this time, the rate of generation and the physical properties (liquid state or solid state) of the deposits derived from the new oil and the used oil can be checked at temperatures in the temperature range of 200 to 700° C.

Also, it has been indicated that the rate of deposit generation is higher with the used oil than with the new oil in the entire range of temperature, and it has been confirmed that the difference in the influence of the deposits depending on the state of the engine oil can be indicated.

Furthermore, it has been confirmed that the temperature at which engine oil entirely changes from liquid into solid is different between the new oil and the used oil.

The pre-processing and the deposit generation test can be performed by using only the thermogravimetry differential thermal analysis (TG-DTA) apparatus that can perform automatic measurement. Thus, the rate of deposit generation can be efficiently evaluated.

The embodiment of the present disclosure enables quantitative and efficient evaluation of the engine oil-derived carbon deposits generated in the environments simulating all the thermal environments of the gasoline engine (the intake system thermal environment, the combustion chamber thermal environment, and the exhaust system thermal environment).

1. A quantitative evaluation method for an engine oil-derived deposit, the quantitative evaluation method comprising:
in an inert gas atmosphere, pre-processing that heats engine oil to 270° C. or higher and holds the engine oil at the heated temperature in a predetermined period of time;
in an air atmosphere, generating a deposit by setting the engine oil having undergone the pre-processing at a fixed temperature and holding the engine oil for 120 minutes or more at the set temperature; and
measuring an amount of deposit generation, the deposit being generated in the generating the deposit.

2. The method according to claim 1,
wherein the pre-processing, the generating the deposit, and the measuring the amount of deposit generation are performed by a simultaneous differential thermal and thermogravimetric analyzer.

3. The method according to claim 1,
wherein time to hold the heated temperature in the pre-processing is 20 minutes or more.

4. The method according to claim 1,
wherein the set temperature in the generating the deposit is any temperature in a temperature range of 200 to 700° C.

5. The method according to claim 1, further comprising:
measuring a weight of the engine oil provided to the pre-processing in the pre-processing; and
calculating a rate of deposit generation according to an expression below after the measuring the amount of deposit generation:
$$Expression$$
$$the amount of deposit generation measured in the measuring$$
$$the amount of deposit generation / the weight of the engine$$
$$oil measured in the measuring the weight of the engine oil \times 100.$$

6. The method according to claim 1, further comprising:
measuring a weight of the engine oil;
in the inert gas atmosphere, pre-processing that heats the engine oil to 270° C. or higher and 300° C. or lower and holds the engine oil at the heated temperature for 20 minutes or more and 40 minutes or less;
in the air atmosphere, generating the deposit by setting the engine oil having undergone the pre-processing at any temperature in a temperature range of 200 to 700° C. and holding the engine oil for 120 minutes or more at the set temperature;
measuring the amount of deposit generation, the deposit being generated in the generating the deposit; and
calculating a rate of deposit generation according to an expression below:
$$the amount of deposit generation measured in the measuring the amount of deposit generation / the weight of the engine oil measured in the measuring the weight of the engine oil \times 100 , \qquad Expression$$
wherein the pre-processing, the generating the deposit, and the measuring the amount of deposit generation are performed by a simultaneous differential thermal and thermogravimetric analyzer.
